(19) United States
(12) Patent Application Publication
(10) Pub. No.: US 2020/0202638 A1
(43) Pub. Date: Jun. 25, 2020

(54) INFORMATION ACQUISITION APPARATUS, INFORMATION ACQUISITION METHOD, AND NON-TRANSITORY STORAGE MEDIUM STORING PROGRAM

(71) Applicant: TOYOTA JIDOSHA KABUSHIKI KAISHA, Toyota-shi (JP)

(72) Inventors: Shin Sakurada, Toyota-shi (JP); Shiroh Ouchi, Nisshin-shi (JP)

(73) Assignee: TOYOTA JIDOSHA KABUSHIKI KAISHA, Toyota-shi (JP)

(21) Appl. No.: 16/666,472

(22) Filed: Oct. 29, 2019

(30) Foreign Application Priority Data
Dec. 21, 2018 (JP) 2018-239477

(51) Int. Cl. G07C 5/00; G07C 5/08

(52) U.S. Cl. CPC G07C 5/008; G07C 5/085

(57) ABSTRACT

An information acquisition apparatus includes a circuitry configured to generate standardized data based on source data output by a vehicle. The source data includes at least one of information on a state of the vehicle, information on an environmental state around the vehicle, and information on a specification of the vehicle. The standardized data represents at least one of the state of the vehicle, the environmental state, and the specification of the vehicle.

### INCORPORATION BY REFERENCE

The disclosure of Japanese Patent Application No. 2018-239477 filed on Dec. 21, 2018 including the specification, drawings and abstract is incorporated herein by reference in its entirety.

### BACKGROUND

### 1. Technical Field

The present disclosure relates to an information acquisition apparatus, an information acquisition method, and a non-transitory storage medium storing a program.

### 2. Description of Related Art

A technology is known in which an external device collects vehicle information (for example, information on a vehicle state, such as a motion state or an operation state of a vehicle, information on environmental state around the vehicle, such as a road surface condition or an outside air temperature condition, and information on a vehicle specification, such as the type of transmission mounted on the vehicle) output by the vehicle and utilizes the vehicle information (for example, see Japanese Unexamined Patent Application Publication No. 2017-004445).

### SUMMARY

However, vehicles of different makes, models, trim levels, or the like, may have completely different, for example, design specifications, such as an electronic control unit (ECU), a detection unit, or a configuration corresponding to a detection target that output vehicle information (for example, data format output by the ECU or the detection unit, a numerical range and response characteristics of a physical quantity that may be generated in various configurations as the detection target, and a placement location in which the detection unit or the configuration corresponding to the detection target is arranged). Therefore, the vehicle information output by a certain vehicle can be compared with vehicle information of the same type acquired in a vehicle of the same make, model, and trim level, but cannot be compared with vehicle information of the same type output by a vehicle of a different make, model, and trim level. Here, the term “comparable information” refers to information of which a similarity, a difference, or the like, can be specified when compared with other information. Accordingly, even though the vehicle information output by a vehicle is collected without modification, there is a possibility that the collected vehicle information is not utilized effectively.

The present disclosure provides an information acquisition apparatus, an information acquisition method, and a non-transitory storage medium storing a program that can acquire vehicle information comparable between any vehicles.

An information acquisition apparatus according to a first aspect of the present disclosure includes an information acquisition apparatus comprising circuitry configured to: generate standardized vehicle information based on source data output by a vehicle, the source data including at least one of information on a state of the vehicle, information on an environmental state around the vehicle, and information on a specification of the vehicle. The standardized vehicle information represents at least one of the state of the vehicle, the environmental state, and the specification of the vehicle.

With above aspect, the information acquisition apparatus can acquire the standardized vehicle information representing the state of the vehicle, the environmental state around the vehicle or the specification of the vehicle, that is, the vehicle information comparable between any vehicles.

In addition, the circuitry may be configured to generate the standardized vehicle information based on information on at least one of a motion state, an operation state, a control state, and an in-vehicle device state of the vehicle, acquired in the vehicle as the state of the vehicle; and the standardized vehicle information may represent at least one of the motion state, the operation state, the control state, and the in-vehicle device state.

With the above aspect, the information acquisition apparatus can acquire the vehicle information comparable between any vehicles, specifically, representing the motion state, the operation state, the control state or the in-vehicle device state of the vehicle.

Further, the circuitry may configured to generate the standardized vehicle information based on information on at least one of a road surface condition, an outside air temperature condition, and a weather condition, acquired in the vehicle as the environmental state; and the standardized vehicle information may represent at least one of the road surface condition, the outside air temperature condition, and the weather condition.

With the above aspect, the information acquisition apparatus can acquire the vehicle information comparable between any vehicles, specifically, representing the road surface condition, the outside air temperature condition, and the weather condition.

Moreover, the circuitry may be configured to generate the standardized vehicle information by converting a numerical value of physical quantity corresponding to at least one of detected information on the state of the vehicle and detected information on the environmental state, acquired in the vehicle, to a relative numerical value with respect to a predetermined reference.

With the above aspect, the information acquisition apparatus can acquire, specifically, the vehicle information comparable between any vehicles, by converting an absolute value of the physical quantity corresponding to the detected information to the relative numerical value with respect to the predetermined reference in common with other vehicles.

In addition, the circuitry may be configured to generate the standardized vehicle information by correcting a numerical value of physical quantity corresponding to at least one of detected information on the state of the vehicle and detected information on the environmental state, to a numerical value when it is assumed that a predetermined standard specification is adopted as a specification of a detection device provided in the vehicle or of a detection target.

With the above aspect, the information acquisition apparatus can acquire, specifically, the vehicle information comparable between any vehicles by correcting the numerical value of the physical quantity corresponding to the detected information to the numerical value obtained by matching the specification of the detection device or the detection target to a standard specification in common with the other vehicles.

Moreover, the circuitry may be configured to generate the standardized vehicle information by correcting an error estimated in a physical quantity corresponding to at least one of the information on the state of the vehicle and the information on the environmental state.

With the above aspect, the information acquisition apparatus can acquire, specifically, the vehicle information comparable between any vehicles by correcting an error inherent in a vehicle on the information output by the vehicle.

Further, the circuitry may be configured to generate the standardized vehicle information by allocating, out of allocation information predefined for each of a plurality of categories, first allocation information predefined for a category corresponding to at least one of the state of the vehicle, the environmental state, and the specification of the vehicle represented by the information included in the source data output by the vehicle, to the information included in the source data.

With the above aspect, the information acquisition apparatus can acquire, specifically, the vehicle information comparable between any vehicles by using the allocation information predefined for the category corresponding to the state of the vehicle, the environmental state around the vehicle or the specification of the vehicle, represented by the information output by the vehicle.

In addition, the information acquisition apparatus may further include a transmission unit configured to transmit the standardized vehicle information to a server outside the information acquisition apparatus.

Moreover, the transmission unit may be configured to transmit the standardized vehicle information in association with identification information of the vehicle to the server.

Further, the information acquisition apparatus may further include a storage unit configured to store the standardized vehicle information.

In addition, the circuitry may be configured to acquire the source data from a plurality of vehicles; and the storage unit may be configured to store the standardized vehicle information in association with identification information of the vehicle that outputs the source data based on which the standardized vehicle information is generated.

In addition, the circuitry may include an electronic control unit mounted on the vehicle; and the electronic control unit may be configured to generate the standardized vehicle information.

In addition, the circuitry may include a processor provided in a server that is installed outside the vehicle; and the processor may be configured to generate the standardized vehicle information.

In addition, an information acquisition method according to a second aspect of the present disclosure includes: generating standardized vehicle information based on source data output by a vehicle, the source data including at least one of information on a state of the vehicle, information on an environmental state around the vehicle, and information on a specification of the vehicle. The standardized vehicle information represents at least one of the state of the vehicle, the environmental state, and the specification of the vehicle.

Further, a third aspect of the present disclosure relates to a non-transitory storage medium storing a program. The program causes, when executed by an information acquisition apparatus, the information acquisition apparatus to generate standardized vehicle information based on source data output by a vehicle, the source data including at least one of information on a state of the vehicle, information on an environmental state around the vehicle, and information on a specification of the vehicle. The standardized vehicle information represents at least one of the state of vehicle, the environmental state, and the specification of the vehicle.

With each aspect of the present disclosure described above, it is possible to provide an information acquisition apparatus, an information acquisition method, and a non-transitory storage medium storing a program that can acquire vehicle information comparable between any vehicles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view illustrating an example of a configuration of a vehicle information collection system;

FIG. 2A is a diagram illustrating an example of a hardware configuration of a vehicle;

FIG. 2B is a diagram illustrating an example of a hardware configuration of a central server; and

FIG. 3 is a functional block diagram illustrating an example of a functional configuration of the vehicle information collection system.

### DETAILED DESCRIPTION OF EMBODIMENTS

Hereinafter, embodiments of the present disclosure will be described with reference to the drawings.

Overview of Vehicle Information Collection System

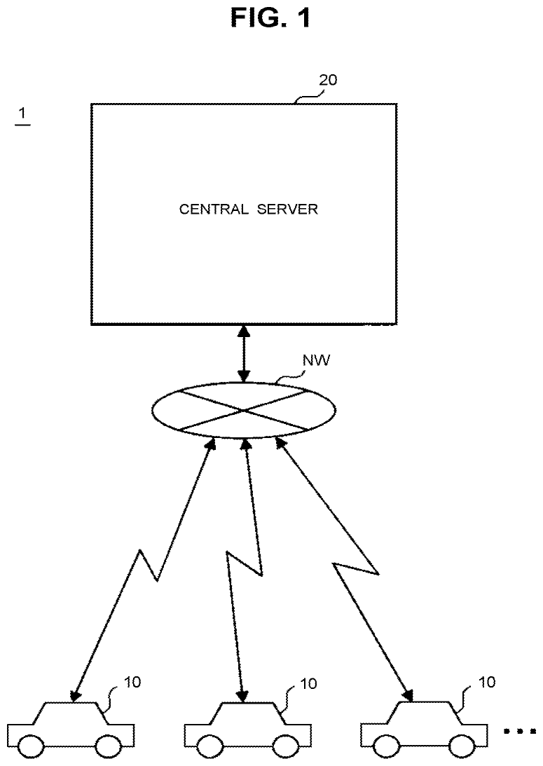

First, an overview of a vehicle information collection system 1 according to the present embodiment will be described with reference to FIG. 1.

The vehicle information collection system 1 includes a plurality of vehicles 10 and a central server 20.

The vehicle information collection system 1 collects and stores, in the central server 20, standardized vehicle information (hereinafter, referred to as “standardized data”), which is acquired in each of the plurality of vehicles 10 and is comparable with any vehicle 10.

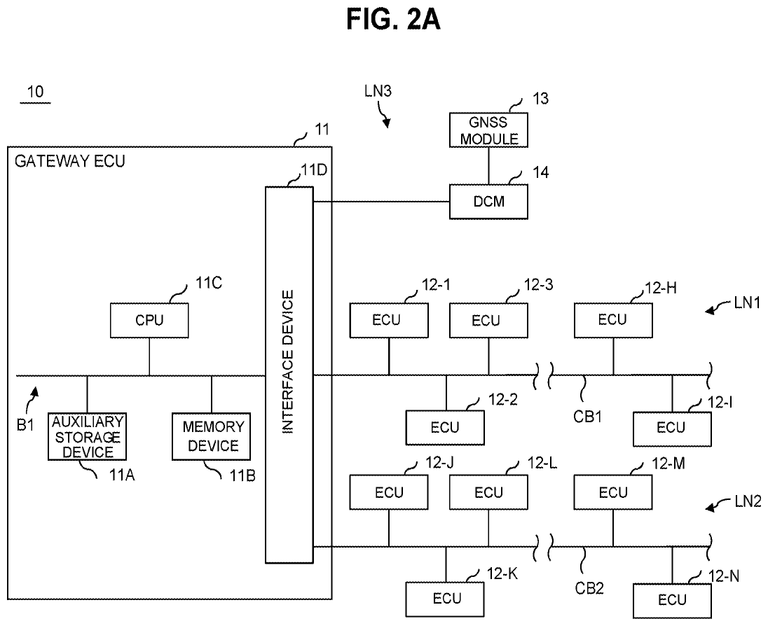

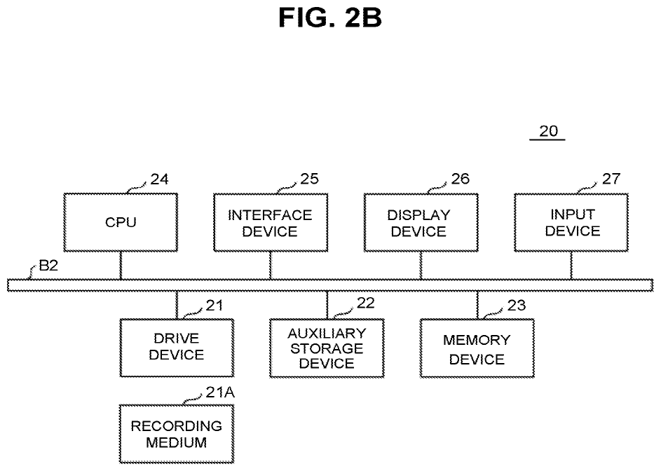

The vehicle 10 is communicably connected to the central server 20 via a communication network NW that may include, for example, a mobile communication network in which a base station is a terminal, a satellite communication network using a communication satellites in orbit, and the Internet network. The vehicle 10 generates the standardized data, indicating a state of the vehicle 10, an environmental state around the vehicle 10, and a specification of the vehicle 10, based on each of source data on the state of the vehicle 10 (hereinafter, referred to as “vehicle state source data”), source data on the environmental state around the vehicle 10 (hereinafter, referred to as “environmental state source data”, and source data on the specification of the vehicle 10 (hereinafter, referred to as “vehicle specification source data”), which are output by the subject vehicle. Here, even if a certain kind of the vehicle state source data, the environmental state source data, or the vehicle specification source data is derived from other kinds of source data, the certain type of source data is still handled as source data since it is the first data, output from among the other kinds of source data. Specifically, the vehicle state source data, the environmental state source data and the vehicle specification source data may be controller area network (CAN) data, which is output from various ECUs 12 (see FIG. 2A) to CAN buses CB1, CB2, and is used for a control of the vehicle 10, as described below. Then, the vehicle 10 uploads (transmits) the generated standardized data to the central server 20 in response to a command from the central server 20, or automatically at a predetermined time.

Alternatively, the vehicle 10 may generate, and upload to the central server 20, a part of the standardized data representing the state of the vehicle 10, the standardized data representing the environmental state around the vehicle 10, and the standardized data representing the specification of the vehicle 10.

Examples of the vehicle state source data may include source data on a motion state of the vehicle 10 (hereinafter, referred to as “motion state source data”), source data on an operation state of the vehicle 10 (hereinafter, referred to as “operation state source data”), source data on a control state of the vehicle 10 (hereinafter, referred to as “control state source data”), and source data on an in-vehicle device state of the vehicle 10 (hereinafter referred to as “in-vehicle device state source data”).

Examples of the motion state source data may include source data on angular velocity, such as a yaw rate of the vehicle 10, output from an angular velocity sensor or the like (hereinafter, referred as to “angular velocity source data”), source data on acceleration of the vehicle 10, output from an acceleration sensor or the like (hereinafter referred to as “acceleration source data”), source data on a wheel speed, output from wheel speed sensors provided on respective wheels of the vehicle 10 or the like (hereinafter, referred to as “wheel speed source data”), source data on a vehicle speed, derived from the wheel speed source data or the like (hereinafter, referred to as “vehicle speed source data”), source data on a braking force acting on the vehicle 10, output from a wheel cylinder pressure sensor (hereinafter, referred to as a “WC pressure sensor”) or the like (hereinafter, referred to as “braking force source data”), and source data on the mileage of the vehicle 10, output from an odometer or the like (hereinafter, referred to as “mileage source data”).

Examples of the operation state source data may include source data on the shift position of a transmission, output from a shift position sensor or the like (hereinafter, referred to as “shift position source data”), source data on the steering angle, output from a steering sensor or the like (hereinafter, referred to as “steering angle source data”), source data on an operation state of the accelerator pedal, output from an accelerator pedal sensor or the like (hereinafter, referred to as “accelerator operation state source data”), source data on an operation state of the brake pedal, output from a stop lamp switch, a brake pedal stroke sensor, a master cylinder pressure sensor (hereinafter, referred to as an “MC pressure sensor”) or the like (hereinafter, referred to as “brake operation state source data”), source data on an operation state of a parking brake, output from a parking brake switch or the like (hereinafter, referred to as “parking brake operation state source data”), source data on an operation state of a turn lamp switch, output from the turn lamp switch or the like (hereinafter, referred to as “turn lamp switch operation state source data”), and source data on an operation state of a hazard lamp switch, output from the hazard lamp switch or the like (hereinafter, referred to as “hazard lamp switch operation state source data”).

Examples of the control state source data may include source data on a working state including whether a traction control system (TCS) function works, output from the ECU 12 that controls the TCS function, or the like (hereinafter, referred to as “TCS working state source data”), source data on a working state including whether an anti-lock braking system (ABS) function works, output from the ECU 12 that controls the ABS function, or the like (hereinafter, referred to as “ABC working state source data”), source data on a working state including whether a lane keeping assist (LKA) function, or a lane departure alert (LDA) function works, output from the ECU 12 that controls the LKA or the LDA function, or the like (hereinafter, referred to as “LKA or LDA working state source data”), source data on a working state including whether a pre-crash safety (PCS) function works, output from the ECU 12 that controls the PCS function, or the like (hereinafter, referred to as “PCS working state source data”), in which the PCS function may include a collision warning function, a brake assist function, and an automatic brake function, and source data on whether an autonomous driving function works, output from the ECU 12 that controls the automatic driving function, that is, source data on whether the vehicle 10 is in an autonomous driving state, or a manual driving state by a driver (hereinafter, referred to as “autonomous driving state source data”).

Examples of the in-vehicle device state source data may include source data on an on or off state of an indicator of an air conditioner, output from the ECU 12 that controls the air conditioner, or the like (hereinafter, referred to as “air conditioner indicator state source data”), source data on a state (on or off state) of a headlamp, output from the ECU 12 that controls the headlamp, or the like (hereinafter referred to as “headlamp state source data”), source data on a state (on or off state) of a tail lamp, output from the ECU 12 that controls the tail lamp, or the like (hereinafter, referred to as “tail lamp state source data”), source data on a state (on or off state) of a stop lamp, output from the stop lamp switch, or the like (hereinafter, referred to as “stop lamp state source data”); and source data on a state (on or off state) of the hazard lamp, output from the hazard lamp switch, or the like (hereinafter, referred to as “hazard lamp state source data”).

Examples of the environmental state source data may include source data on a road surface condition including a road surface μ (friction coefficient), or a road grade, output (estimated) by the ECU 12 that controls the TCS function, the ECU 12 that controls the ABS function, or the like (hereinafter, referred to as “road surface condition source data”), source data on a condition of the outside air temperature around the vehicle 10, output from an outside air temperature sensor or the like (hereinafter, referred to as “outside air temperature condition source data”), and source data on a weather condition including solar radiation degree, or presence or absence of rainfall around the vehicle 10, output from a rain sensor, an illuminance sensor, or the like (hereinafter, referred to as “weather condition source data”).

Examples of the vehicle specification source data may include source data on the type of the transmission (specifically, whether the type is automatic, manual, continuously variable, unknown, or the like), output from the ECU 12 that controls the transmission of the vehicle 10, or the like (hereinafter, referred to as “transmission type source data”), and source data on a type of the air conditioner (specifically, when setting the temperature, whether the temperature is commonly set for all seats, or whether the temperature is independently set between two zones, a left and a right, among three zones, left and right seats in the front and rear seats, or among four zones, left and right seats in the front and left and right seats in the rear, whether the type is unknown, or the like), output from the ECU 12 that controls the air conditioner of the vehicle 10, or the like (hereinafter, referred to as “air conditioner type source data”).

The central server 20 is communicably connected to each of the plurality of vehicles 10 via the communication network NW. The central server 20 receives the standardized data transmitted from the each of the plurality of vehicles 10 and stores the received standardized data for each vehicle 10.

Configuration of Information Collection System

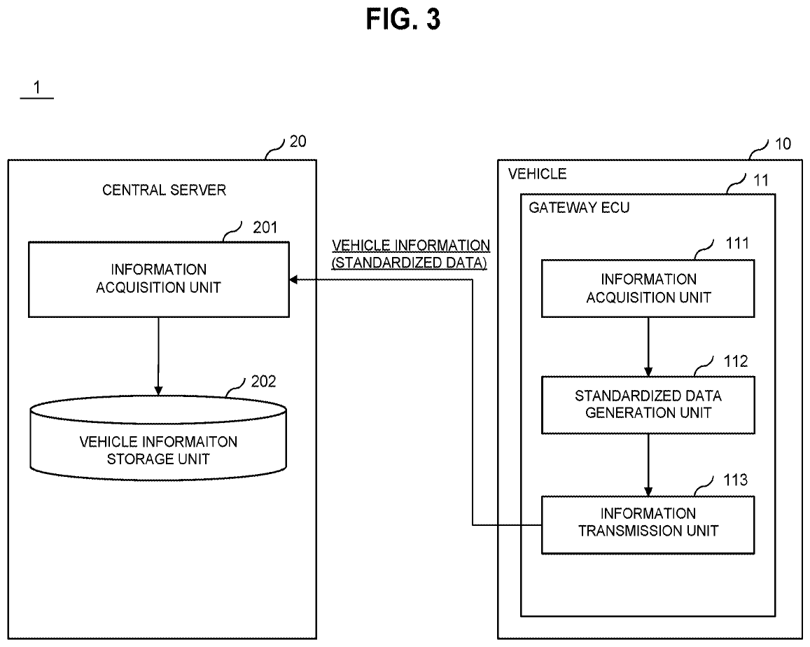

Next, a configuration of vehicle information collection system 1 will be described with reference to FIGS. 2A, 2B, and 3 in addition to FIG. 1.

FIGS. 2A and 2B are a diagram illustrating an example of a hardware configuration of the vehicle information collection system 1. Specifically, FIG. 2A is a diagram illustrating an example of a hardware configuration of the vehicle 10, and FIG. 2B is a diagram illustrating an example of a hardware configuration of the central server 20. Moreover, FIG. 3 is a functional block diagram illustrating an example of a functional configuration of the vehicle information collection system 1.

Configuration of Vehicle

As illustrated in FIG. 2A, the vehicle 10 includes a gateway ECU 11, a plurality of ECUs 12, a global navigation satellite system (GNSS) module 13, and a data communication module (DCM) 14.

The gateway ECU 11 (an example of the information acquisition apparatus) controls a gateway function between in-vehicle networks LN1, LN2 including the plurality of ECUs 12, and an in-vehicle network LN3 including the DCM 14, which is an interface with the communication network NW outside the vehicle 10. Functions of the gateway ECU 11 may be implemented by any hardware or by a combination of hardware and software. For example, the gateway ECU 11 may mainly consist of a microcomputer including an auxiliary storage device 11A, a memory device 11B, a central processing unit (CPU) 11C, an interface device 11D, and the like, each of which is connected via the bus B1. The ECU 12 hereinafter may have a similar hardware configuration.

A program for implementing various functions of the gateway ECU 11 is provided by, for example, a dedicated tool connected via a detachable cable to a predetermined connector for external connection (for example, a datalink coupler (DLC)), which is connected to the in-vehicle network of the vehicle 10, based on, for example, a CAN protocol. The program is installed from the dedicated tool to the auxiliary storage device 11A of the gateway ECU 11 via the cable, the connector and the in-vehicle network, in response to a predetermined operation on the dedicated tool. Moreover, the program may be downloaded from another computer (for example, the central server 20) via the communication network NW and installed in the auxiliary storage device 11A. The same applies to the ECU 12 hereinafter.

The auxiliary storage device 11A is a non-volatile storage unit and stores the installed program and necessary files, data, or the like. Examples of the auxiliary storage device 11A include a hard disk drive (HDD) and a flash memory.

The memory device 11B reads the program from the auxiliary storage device 11A and stores the program when there is an instruction to start the program.

The CPU 11C executes the program stored in the memory device 11B and implements various functions of the gateway ECU 11 according to the program.

The interface device 11D is used as an interface for, for example, connecting to the in-vehicle networks LN1 to LN3, or connecting one-to-one to various sensors, actuators, and the like. The interface device 11D may include a plurality of different kinds of interface devices depending on connection targets.

The ECU 12 controls a predetermined function on the vehicle 10. The plurality of ECUs 12 belong to any one of the in-vehicle networks LN1, LN2 based on the CAN protocol. Hereinafter, the plurality of ECUs 12 are distinguishably described as ECU 12-1, 12-2, 12-3, . . . , 12-H (H is an integer of 4 or more), 12-I (I=H+1), 12-J (J=I+1), 12-K (K=J+1), 12-L (L=K+1), . . . , 12-M (M=N−1), and 12-N (N is an integer of 10 or more).

The number of ECUs 12 belonging to each of the in-vehicle networks LN1, LN2 is merely an example and may be four or less. Further, the in-vehicle networks LN1, LN2 to which the plurality of ECUs 12 belong are merely examples, and the in-vehicle network to which the plurality of ECUs 12 belong is not limited thereto. The plurality of ECUs 12 may belong to any of three or more in-vehicle networks, or belong to a single in-vehicle network. Moreover, the ECU 12 may be a single ECU. In addition, the gateway ECU 11 and the plurality of ECUs 12 may constitute the in-vehicle network based on a communication protocol (for example, an in-vehicle Ethernet protocol, or a FlexRay communication protocol) other than the CAN protocol.

The ECUs 12-1 to 12-I are each connected to a line-type CAN bus CB1, and constitute, together with the gateway ECU 11, the in-vehicle network LN1 based on the CAN protocol. The ECUs 12-1 to 12-I each output at least one of different kinds of vehicle state source data, environmental state source data, and vehicle specification source data.

The ECUs 12-J to 12-N are each connected to a line-type CAN bus CB2, and constitute, together with the gateway ECU 11, the in-vehicle network LN2 based on the CAN protocol. The ECUs 12-J to 12-N each output at least one of different kinds of vehicle state source data, environmental state source data, and vehicle specification source data.

CAN data corresponding to the vehicle state source data or the environmental state source data, output from the ECUs 12-1 to 12-N to the CAN buses CB1, CB2, may be, for example, the detected data acquired from a detection unit (for example, a sensor or a switch) under the control of each of ECUs 12-1 to 12-N. The CAN data corresponding to the vehicle state source data or the environmental state source data, output from the ECUs 12-1 to 12-N to the CAN buses CB1, CB2, may be, for example, data derived from the acquired detected data (for example, vehicle speed data derived from the detected data from the wheel speed sensor, or estimated data on the road surface μ or the road grade). Moreover, the vehicle specification source data output from the ECUs 12-1 to 12-N to the CAN buses CB1, CB2 may be, for example, data on the specification of the vehicle 10 held (stored) by each of the ECUs 12-1 to 12-N.

The GNSS module 13 locates the vehicle 10 (the subject vehicle) on which it is mounted by receiving a satellite signal transmitted from three or more, preferably four or more, satellites in orbit over the vehicle 10. Positioning information of the GNSS module 13, that is, position information of the vehicle 10 is acquired by the DCM 14 via, for example, a one-to-one communication line or the in-vehicle network. Further, the positioning information of the GNSS module 13 may be acquired by the gateway ECU 11 or the ECU 12 via, for example, the in-vehicle networks LN1 to LN3.

The DCM 14 is an example of a communication device for connecting the communication network NW outside the vehicle 10, and communicating with an external device including the central server 20 via the communication network NW. The DCM 14 transmits to and receives from the central server 20 various signals (for example, an information signal and a control signal). Further, the DCM 14 is communicably connected to the gateway ECU 11 via the in-vehicle network LN3. The DCM 14 transmits various signals to entities outside the vehicle 10 in response to a request from the gateway ECU 11, or outputs signals received from entities outside the vehicle 10 via the in-vehicle network LN3 to the gateway ECU 11. Similar to the in-vehicle networks LN1, LN2, the in-vehicle network LN3 may be a network based on a network based on the CAN protocol, or to a communication protocol other than the CAN protocol.

As illustrated in FIG. 3, the gateway ECU 11 includes, for example, an information acquisition unit 111, a standardized data generation unit 112 and an information transmission unit 113 as functional units implemented by executing one or more programs installed in the auxiliary storage device 11A on the CPU 11C.

The information acquisition unit 111 acquires the CAN data of the CAN buses CB1, CB2.

The standardized data generation unit 112 generates the standardized data, as the standardized vehicle information representing the state of vehicle 10, the environmental state around the vehicle 10 or the specification of the vehicle 10, corresponding to the CAN data, based on the CAN data acquired by the information acquisition unit 111. Details of a method for generating the standardized data will be described below.

The information transmission unit 113 acquires, or causes the DCM 14 to acquire, the standardized data generated by the standardized data generation unit 112 for every predetermined period (for example, every several seconds or every several minutes), and transmits the acquired data to the central server 20 via the DCM 14. Specifically, the information transmission unit 113 may transmit, to the central server 20, a signal including identification information for specifying the vehicle 10 that is a transmission source (for example, a vehicle identification number (VIN) of the vehicle 10, or a vehicle identifier (ID) predefined for each of the plurality of vehicles 10) (hereinafter, referred to as “vehicle identification information”), information on a date and time at which the source data corresponding to the standardized data is acquired (for example, a time stamp) (hereinafter, referred to as “acquisition date and time information”), the position information of the vehicle 10 on such a date and time, and the standardized data. As such, the central server 20 can identify (specify) the vehicle 10 as the transmission source of the signal including the standardized data, or specify the date and time at which the source data corresponding to the standardized data is acquired (the time at which the data is acquired) or the position information of the vehicle 10 on such a date and time.

Further, the function of the information transmission unit 113 may be transferred to the DCM 14.

Configuration of Central Server

Functions of the central server 20 may be implemented by any hardware, or by a combination of hardware and software. As illustrated in FIG. 2B, the central server 20 includes, for example, a drive device 21, an auxiliary storage device 22, a memory device 23, a CPU 24, an interface device 25, a display device 26, and an input device 27, each connected to the bus B2.

A program for implementing various functions of the central server 20 is provided by, for example, a portable recording medium 21A, such as a compact disc-read only memory (CD-ROM), a digital versatile disc-read only memory (DVD-ROM), and a universal serial bus (USB) memory. When the recording medium 21A on which the program is recorded is set in the drive device 21, the program is installed in the auxiliary storage device 22 from the recording medium 21A via the drive device 21. Alternatively, the program may be downloaded from another computer via the communication network, and installed in the auxiliary storage device 22.

The auxiliary storage device 22 stores various installed programs, and necessary files, data, or the like.

The memory device 23 reads the program from the auxiliary storage device 22 and stores the program when there is an instruction to start the program.

The CPU 24 executes the various programs stored in the memory device 23, and implements various functions of the central server 20 according to the programs.

The interface device 25 is used as an interface for connecting to the communication network (for example, the communication network NW).

The display device 26 displays, for example, a graphical user interface (GUI) according to the program executed by the CPU 24.

The input device 27 is used to enable an operator or a manager of the central server 20 to input various operation instructions related to the central server 20.

As illustrated in FIG. 3, the central server 20 includes, for example, an information acquisition unit 201 as a functional unit implemented by executing one or more programs installed in the auxiliary storage device 22 on the CPU 24. Further, the central server 20 uses a vehicle information storage unit 202, and the like. The vehicle information storage unit 202 can be implemented, for example, by using the auxiliary storage device 22 or an external storage device communicably connected to the central server 20.

The information acquisition unit 201 acquires the standardized data received from each vehicle 10 as the vehicle information, and stores (accumulates) the data in the vehicle information storage unit 202. Specifically, the information acquisition unit 201 stores the standardized data received from the vehicle 10 in the vehicle information storage unit 202 as a record in association with the vehicle identification information, the acquisition date and time information, and the position information of the vehicle 10.

The vehicle information storage unit 202 stores the standardized data received from the vehicle 10 as described above. Specifically, the vehicle information storage unit 202 may hold a record cluster (that is, a database) of the standardized data acquired in the plurality of vehicles 10 by accumulating the record including the vehicle identification information, the acquisition date and time information, and the position information of the vehicle 10, and the standardized data. Further, the vehicle information storage unit 202 may be provided with a dedicated vehicle information storage unit for each of the plurality of vehicles 10, and each of the dedicated vehicle information storage units may hold a history of the record (that is, the record cluster) including the acquisition date and time information, the position information, and the standardized data for each vehicle 10.

Method for Generating Standardized Data

Hereinafter, a specific method for generating the standardized data by the standardized data generation unit 112 of the vehicle 10 will be described.

First Example of Method for Generating Standardized Data

The standardized data generation unit 112 may generate the standardized data by converting a numerical value of the physical quantity corresponding to detected information on the state of the vehicle 10 (as the vehicle state source data), or detected information on the environmental state around the vehicle 10 as the environmental state source data, to a relative numerical value with respect to a predetermined reference.

For example, the standardized data generation unit 112 may convert detected information of the MC pressure sensor (as the brake operation state source data), that is, a detected value of the MC pressure, to an operation value of the brake pedal represented by a relative ratio (for example, 0% to 100%) based on an MC pressure of the vehicle 10 corresponding to a state where the operation value of the brake pedal is zero, and an MC pressure of the vehicle 10 corresponding to a state where the operation value of the brake pedal is maximum, as a reference. It is likely that the MC pressure cannot be compared with that of another vehicle 10 since its absolute value or response characteristics may be different depending on, for example, various specifications, design specifications or the like of the vehicle 10. On the other hand, a degree to which the brake pedal of the vehicle 10 has been operated can be compared with that of the another vehicle 10 by converting the detected value of the MC pressure to the operation value of the brake pedal represented by a relative ratio.

Moreover, for example, the standardized data generation unit 112 may convert detected information of the outside air temperature sensor (as the environmental state source data), that is, a detected value of the outside air temperature, to a relative numerical value based on the assumed design temperature of the vehicle 10 as a reference (for example, a positive or negative deviation from the assumed temperature). Since each vehicle 10 has a different temperature environment, that is, the assumed design temperature of the vehicle 10, depending on the country from which the vehicle 10 is shipped, it is likely that the influence of the outside air temperature on the vehicle 10 cannot be compared with another vehicle by merely comparing absolute values of the outside air temperatures. On the other hand, the influence of the outside air temperature on the vehicle 10 can be compared with the another vehicle 10 by converting the detected value of the outside air temperature to the relative value based on the assumed design temperature as a reference.

Second Example of Method for Generating Standardized Data

The standardized data generation unit 112 may generate the standardized data by correcting the numerical value of the physical quantity corresponding to the detected information on the state of the vehicle 10 (as the vehicle state source data), or the detected information on the environmental state around the vehicle 10 as the environmental state source data, to a numerical value when it is assumed that a predetermined standard specification is adopted as a specification of the detection unit or of a detection target.

For example, the standardized data generation unit 112 may correct the detected information of the WC pressure sensor (as the vehicle state source data), that is, a detected value of the WC pressure, to a WC pressure generating a braking force required when it is assumed that the vehicle 10 has a reference vehicle weight (hereinafter, referred to as “reference weight”). Although the WC pressure is the same, the generated braking force may be different if the vehicle weight of the vehicle 10 is different. Thus it is likely that the braking force generated in the vehicle 10 cannot be compared with that of another vehicle 10. On the other hand, the braking force generated in the vehicle 10 can be compared with that of the another vehicle 10 by correcting the detected value of the WC pressure to the WC pressure generating the braking force required when it is assumed that the vehicle 10 has a reference weight.

Further, for example, the standardized data generation unit 112 corrects the detected information of the outside air temperature sensor (as the environmental state source data), that is, a detected value of the outside air temperature, to an outside air temperature when it is assumed that the outside air temperature sensor is at a reference installation site (hereinafter, referred to as “reference installation site”). Since the outside air temperature sensor may be installed at a different installation site depending on the vehicle 10, the detected value may be different depending on the installation site even though the outside air temperature around the vehicle 10 is the same. Therefore, it is likely that the outside air temperature condition around the vehicle 10 cannot be compared with that of another vehicle 10 by merely comparing the detected values of the outside air temperature sensors without any correction. On the other hand, the outside air temperature condition of the vehicle 10 can be compared with that of the another vehicle 10 by correcting the detected value of the outside air temperature when it is assumed the outside air temperature sensor is installed at the reference installation site.

Third Example of Method for Generating Standardized Data

The standardized data generation unit 112 may generate standardized vehicle information by correcting an error estimated in the physical quantity corresponding to the vehicle state source data or the environmental state source data. The reason is that the physical quantity detected or derived in the vehicle 10 may include an error component.

Fourth Example of Method for Generating Standardized Data

The standardized data generation unit 112 may generate the standardized vehicle information by allocating allocation information to the information output by the vehicle 10, out of allocation information predefined for each of a plurality of categories. The allocation information is predefined for a category corresponding to the state of the vehicle 10, the environmental state around the vehicle 10, or the specification of the vehicle 10, represented by the information output by the vehicle 10.

For example, the standardized data generation unit 112 may allocate predetermined allocation information corresponding to a shift position of a transmission, represented by detected information of the shift position sensor (as the vehicle state source data), to such detected information. Specifically, in the case of automatic transmissions, different numerical values (for example, 1, 2, 3, and 4) are predefined for a parking position, a reverse position, a neutral position, and a drive position, respectively. A numerical value corresponding to the shift position represented by the detected information of the shift position sensor is allocated. As such, since the same fixed numerical value is always assigned to the same shift position state, the selected shift position of the vehicle 10 can be compared with that of another vehicle 10 with the allocation information (numerical value) only.

Further, for example, the standardized data generation unit 112 allocates the allocation information predefined for each of a plurality of temperature zones predefined to the detected information of the outside air temperature sensor (as the environmental state source data). Specifically, in the case where five temperature zones are defined, different numerical values (for example, 10, 20, 30, 40, and 50) are predefined for the temperature zones, respectively. A numerical value corresponding to the outside air temperature (detected value) represented by the detected information of the outside air temperature sensor is allocated. As such, since the same fixed numerical value is always assigned to the same temperature zone, the outside air temperature condition of the vehicle 10 can be compared with that of another vehicle 10, based on the temperature zone with the allocation information (numerical value) only.

Further, for example, the standardized data generation unit 112 may allocate the predetermined allocation information predefined for each of the transmission types to the transmission type source data (as the vehicle specification source data). Specifically, different numerical values (for example, 2, 4, and 6) are predefined for transmission types, such as an automatic transmission, a manual transmission, and a continuously variable transmission, respectively. A numerical value corresponding to the transmission type represented by the transmission type source data is allocated. As such, since the same fixed numerical value is always assigned to the same transmission kind, the transmission kind of the vehicle 10 can be compared with that of another vehicle 10 with the allocation information (numerical value) only.

Fifth Example of Method for Generating Standardized Data

The standardized data generation unit 112 may generate the standardized data by converting a unit of the physical quantity corresponding to the detected information on the state of the vehicle 10 (as the vehicle state source data), or the detected information on the environmental state around the vehicle 10 (as the environmental state source data), to a predefined standard unit system (for example, an SI unit system). The reason is that a unique unit system may be used in the vehicle 10 depending on, for example, the country from which the vehicle 10 is shipped.

Other Examples of Method for Generating Standardized Data

The methods described in the first to fifth examples may be used in combination as appropriate when generating certain kinds of the standardized data. For example, when generating the operation value of the brake pedal as the standardized data in the first example above, the standardized data generation unit 112 may further adopt the third example to correct the errors in the MC pressure.

### Operation of Present Embodiment

An operation of the vehicle information collection system 1 (the gateway ECU 11 of the vehicle 10) according to the present embodiment will be described below.

In the present embodiment, the standardized data generation unit 112 generates the standardized vehicle information (standardized data), based on the information on the state of the vehicle 10 (vehicle state source data), the information on the environmental state around the vehicle 10 (environmental state source data), or the information on the specification of the vehicle 10 (vehicle specification source data), output by the vehicle 10. The standardized vehicle information represents the state of the vehicle 10, the environmental state around the vehicle 10, or the specification of the vehicle 10.

As such, the gateway ECU 11 can acquire the standardized vehicle information indicating the state of the vehicle 10, the environmental state around the vehicle 10, or the specification of the vehicle 10, that is, the vehicle information comparable between any vehicles 10. Therefore, since the central server 20 can acquire the vehicle information (standardized data) comparable with any vehicle 10 from each of the plurality of vehicles 10, it is possible to compare the vehicle information collected from the plurality of vehicles 10, thereby effectively utilizing the information via, for example, statistical processing.

Further, in the present embodiment, the standardized data generation unit 112 may generate the standardized vehicle information representing the motion state, the operation state, the control state, or the in-vehicle device state of the vehicle 10, based on the information on the motion state, the operation state, the control state, or the in-vehicle device state of the vehicle 10 (the motion state source data, the operation state source data, the control state source data, or the in-vehicle device state source data), acquired in the vehicle 10 as the state of the vehicle 10.

As such, the gateway ECU 11 can acquire the vehicle information comparable between any vehicles 10, which specifically represents the motion state, the operation state, the control state, or the in-vehicle device state of the vehicle 10.

Further, in the present embodiment, the standardized data generation unit 112 may generate the standardized vehicle information representing the road surface condition, the outside air temperature condition, or the weather condition, based on the information on the road surface condition, the outside air temperature condition, or the weather condition (the road surface condition source data, the outside air temperature condition source data, or the weather condition source data), acquired in the vehicle 10 as the environmental state around the vehicle 10.

As such, the gateway ECU 11 can acquire the vehicle information comparable between any vehicles 10, which specifically represents the road surface condition, the outside air temperature condition, or the weather condition.

Further, in the present embodiment, the standardized data generation unit 112 may generate the standardized vehicle information by converting the numerical value of the physical quantity corresponding to the detected information on the state of the vehicle 10 (as the vehicle state source data), or the detected information on the environmental state around the vehicle 10 (as the environmental state source data), acquired in the vehicle 10, to a relative numerical value with respect to the predetermined reference.

As such, the gateway ECU 11 can specifically acquire the vehicle information comparable between any vehicles 10, by converting an absolute value of the physical quantity corresponding to the detected information to the relative numerical value with respect to the predetermined reference in common with the other vehicles 10.

Further, in the present embodiment, the standardized data generation unit 112 may generate the standardized vehicle information by correcting the numerical value of the physical quantity corresponding to the detected information on the state of the vehicle 10 (as the vehicle state source data), and the detected information on the environmental state around the vehicle 10 (as the environmental state source data), to a numerical value when it is assumed that the predetermined standard specification is adopted as the specification of the detection unit or the detection target.

As such, the gateway ECU 11 can specifically acquire the vehicle information comparable between any vehicles 10, by correcting the numerical value of the physical quantity corresponding to the detected information to the numerical value obtained by matching the specification of the detection unit or the detection target to the standard specification in common with the other vehicles 10.

Further, in the present embodiment, the standardized data generation unit 112 may generate the standardized vehicle information by correcting the error estimated in the physical quantity corresponding to the information on the state of the vehicle 10 (the vehicle state source data) or the information on the environmental state around the vehicle 10 (the environmental state source data).

As such, the gateway ECU 11 can specifically acquire the vehicle information comparable between any vehicles 10, by correcting the error inherent in the vehicle 10 on the information output by the vehicle 10.

Further, in the present embodiment, the standardized data generation unit 112 may generate the standardized vehicle information by allocating the allocation information to the information output by the vehicle 10, out of allocation information predefined for each of a plurality of categories. The allocation information is predefined for a category corresponding to the state of the vehicle 10, the environmental state around the vehicle 10, or the specification of the vehicle 10, represented by the information output by the vehicle 10.

As such, the gateway ECU 11 can specifically acquire the vehicle information comparable between any vehicles 10 by using the allocation information predefined for the category corresponding to the state of the vehicle 10, the environmental state around the vehicle 10, or the specification of the vehicle 10, represented by the information output by the vehicle 10.

As above, the embodiments for implementing the present disclosure was described in full detail. However, the present disclosure is not limited to such a specific embodiment, and various modifications and improvements may be implemented within the technical scope of the disclosure that is claimed in the claims.

For example, in the embodiments described above, the function of the standardized data generation unit 112 of the vehicle 10 may be transferred to the central server 20 (an example of the information acquisition apparatus). In this case, the information transmission unit 113 of the vehicle 10 transmits the CAN data acquired by the information acquisition unit 111 to the central server 20. As such, the central server 20 can generate the standardized data for each of the plurality of vehicles 10, based on the CAN data received from each vehicle 10.

What is claimed is:

1. An information acquisition apparatus comprising circuitry configured to:
generate standardized vehicle information based on source data output by a vehicle, the source data including at least one of information on a state of the vehicle, information on an environmental state around the vehicle, and information on a specification of the vehicle,
wherein the standardized vehicle information represents at least one of the state of the vehicle, the environmental state, and the specification of the vehicle.

2. The information acquisition apparatus according to claim 1, wherein:
the circuitry is configured to generate the standardized vehicle information based on information on at least one of a motion state, an operation state, a control state, and an in-vehicle device state of the vehicle, acquired in the vehicle as the state of the vehicle; and
the standardized vehicle information represents at least one of the motion state, the operation state, the control state, and the in-vehicle device state.

3. The information acquisition apparatus according to claim 1, wherein:
the circuitry is configured to generate the standardized vehicle information based on information on at least one of a road surface condition, an outside air temperature condition, and a weather condition, acquired in the vehicle as the environmental state; and
the standardized vehicle information represents at least one of the road surface condition, the outside air temperature condition, and the weather condition.

4. The information acquisition apparatus according to claim 1, wherein
the circuitry is configured to generate the standardized vehicle information by converting a numerical value of physical quantity corresponding to at least one of detected information on the state of the vehicle and detected information on the environmental state, acquired in the vehicle, to a relative numerical value with respect to a predetermined reference.

5. The information acquisition apparatus according to claim 1, wherein
the circuitry is configured to generate the standardized vehicle information by correcting a numerical value of physical quantity corresponding to at least one of detected information on the state of the vehicle and detected information on the environmental state, to a numerical value when it is assumed that a predetermined standard specification is adopted as a specification of a detection device provided in the vehicle or of a detection target.

6. The information acquisition apparatus according to claim 1, wherein
the circuitry is configured to generate the standardized vehicle information by correcting an error estimated in a physical quantity corresponding to at least one of the information on the state of the vehicle and the information on the environmental state.

7. The information acquisition apparatus according to claim 1, wherein
the circuitry is configured to generate the standardized vehicle information by allocating, out of allocation information predefined for each of a plurality of categories, first allocation information predefined for a category corresponding to at least one of the state of the vehicle, the environmental state, and the specification of the vehicle represented by the information included in the source data output by the vehicle, to the information included in the source data.

8. The information acquisition apparatus according to claim 1, further comprising a transmission unit configured to transmit the standardized vehicle information to a server outside the information acquisition apparatus.

9. The information acquisition apparatus according to claim 8, wherein the transmission unit is configured to transmit the standardized vehicle information in association with identification information of the vehicle to the server.

10. The information acquisition apparatus according to claim 1, further comprising a storage unit configured to store the standardized vehicle information.

11. The information acquisition apparatus according to claim 10, wherein:
the circuitry is configured to acquire the source data from a plurality of vehicles; and
the storage unit is configured to store the standardized vehicle information in association with identification information of the vehicle that outputs the source data based on which the standardized vehicle information is generated.

12. The information acquisition apparatus according to claim 1, wherein:
the circuitry includes an electronic control unit mounted on the vehicle; and
the electronic control unit is configured to generate the standardized vehicle information.

13. The information acquisition apparatus according to claim 1, wherein:
the circuitry includes a processor provided in a server that is installed outside the vehicle; and
the processor is configured to generate the standardized vehicle information.

14. An information acquisition method comprising:
generating standardized vehicle information based on source data output by a vehicle, the source data including at least one of information on a state of the vehicle, information on an environmental state around the vehicle, and information on a specification of the vehicle,
wherein the standardized vehicle information represents at least one of the state of the vehicle, the environmental state, and the specification of the vehicle.

15. The information acquisition method according to claim 14, wherein:
the generating standardized vehicle information includes generating the standardized vehicle information based on information on at least one of a motion state, an operation state, a control state, and an in-vehicle device state of the vehicle, acquired in the vehicle as the state of the vehicle; and
the standardized vehicle information represents at least one of the motion state, the operation state, the control state, and the in-vehicle device state.

16. The information acquisition method according to claim 14, wherein:
the generating standardized vehicle information includes generating the standardized vehicle information based on information on at least one of a road surface condition, an outside air temperature condition, and a weather condition, acquired in the vehicle as the environmental state; and
the standardized vehicle information represents at least one of the road surface condition, the outside air temperature condition, and the weather condition.

17. The information acquisition method according to claim 14, wherein:
the generating standardized vehicle information includes generating the standardized vehicle information by converting a numerical value of physical quantity corresponding to at least one of detected information on the state of the vehicle and detected information on the environmental state, acquired in the vehicle, to a relative numerical value with respect to a predetermined reference.

18. The information acquisition method according to claim 14, wherein:
the generating standardized vehicle information includes generating the standardized vehicle information by correcting a numerical value of physical quantity corresponding to at least one of detected information on the state of the vehicle and detected information on the environmental state, to a numerical value when it is assumed that a predetermined standard specification is adopted as a specification of a detection device provided in the vehicle or of a detection target.

19. The information acquisition method according to claim 14, wherein:
the generating standardized vehicle information includes generating the standardized vehicle information by correcting an error estimated in a physical quantity corresponding to at least one of the information on the state of the vehicle and the information on the environmental state.

20. A non-transitory storage medium storing a program, the program causing, when executed by an information acquisition apparatus, the information acquisition apparatus to:
generate standardized vehicle information based on source data output by a vehicle, the source data including at least one of information on a state of the vehicle, information on an environmental state around the vehicle, and information on a specification of the vehicle,
wherein the standardized vehicle information represents at least one of the state of the vehicle, the environmental state, and the specification of the vehicle.
